(19) United States
(12) Patent Application Publication
(10) Pub. No.: US 2024/0347800 A1
(43) Pub. Date: Oct. 17, 2024

(54) Method for recycling Li-ion batteries

(71) Applicant: SMS group GmbH, Düsseldorf (DE)

(72) Inventors: Stephan GEIMER, Mühlheim (DE); Markus Andreas REUTER, Düsseldorf (DE); Nikolaus Peter Kurt BOROWSKI, Düsseldorf (DE); Erik HECKER, Krefeld (DE)

(73) Assignee: SMS group GmbH, Düsseldorf (DE)

(21) Appl. No.: 18/579,340

(22) PCT Filed: Jul. 11, 2022
(86) PCT No.: PCT/EP2022/069343

§ 371 Date: Jan. 13, 2024

(30) Foreign Application Priority Data
Jul. 15, 2021 (DE) 10 2021 207 544.4

(51) Int. Cl. H01M 10/54; B09B 3/35; B09B 3/40; B09B 3/70; B09B 101/16

(52) U.S. Cl. CPC H01M 10/54; B09B 3/35; B09B 3/40; B09B 3/70; B09B 2101/16

(57) ABSTRACT

Lithium-containing electrochemical energy storage devices a recycled by the following steps: i) The electrochemical energy storage devices are initially comminuted and a fraction comprising an active material is separated from the comminuted material. The fraction includes carbon (C), lithium (Li) and at least one of cobalt (Co), manganese (Mn), nickel (Ni), or iron (Fe). ii) The fraction comprising active material is subsequently fed to a melt-down unit and is melted down in the presence of slag-forming agents so that a molten slag phase and a molten metal phase are formed, iii) Then, the lithium (Li) contained in the molten slag phase and/or molten metal phase is converted into a gas phase by the addition of a fluorinating agent and the carbon (C) is converted into a gas phase by the addition of an oxygen-containing gas, and the lithium and carbon are withdrawn from the process as discharge gas.

### CROSS-REFERENCE TO RELATED APPLICATION

This application is a national stage application, filed under 35 U.S.C. § 371, of International Patent Application PCT/EP2022/069343, filed on Jul. 11, 2022, which claims the benefit of German Patent Application DE 10 2021 207 544.4, filed on Jul. 15, 2021.

### TECHNICAL FIELD

The present disclosure relates to a method for recycling lithium-containing electrochemical energy storage devices, in particular cells and/or batteries.

### BACKGROUND

As a result of the increasing electrification of the automotive sector, global demand for the element lithium, which is a key component of lithium-ion batteries, is rising. In order to recover the valuable raw materials contained therein, such as lithium, cobalt, nickel, manganese, iron, aluminum, copper or vanadium, as efficiently as possible, methods are required in which hydrometallurgical treatment can be reduced to a minimum.

With the methods known from the prior art, the lithium-ion batteries are initially discharged and subsequently crushed under inert gas. The coarse material is then separated from the electrolyte and dried in a thermal conditioning step. The fractions resulting from the processing steps are the electrolyte, which contains lithium in the form of lithium hexafluorophosphate; an active material that, in addition to graphite, contains the valuable transition metals and lithium; metal foils with adhesions of active material; various plastics and housing parts.

The separated active material is subsequently further treated and processed using hydro- and/or pyrometallurgical methods. Thereby, a portion of the raw materials contained, such as graphite, cobalt, manganese, iron, aluminum, copper or vanadium, are extracted in various stages. The lithium is usually only extracted in further stages of a recycling process.

A method is also known from WO 2020/104164 A1 with which a large proportion of lithium can be fumed off as lithium chloride from a slag phase by adding alkali metal chloride and/or alkaline earth metal chloride.

### SUMMARY

The present disclosure provides a method for recycling lithium-containing electrochemical energy storage devices, in particular cells and/or batteries, which is improved compared to the prior art, and in particular of provides a method for recycling lithium-containing electrochemical energy storage devices that enable hydrometallurgical treatment to be reduced to a minimum.

In the method for recycling lithium-containing electrochemical energy storage devices, in particular cells and/or batteries, i) the electrochemical energy storage devices are initially comminuted, wherein a fraction comprising an active material is separated from the comminuted material, wherein the fraction comprises active material having carbon (C), lithium (Li) and at least one of the elements selected from the series comprising cobalt (Co), manganese (Mn), nickel (Ni), iron (Fe) and/or combinations thereof. The fraction comprising active material is subsequently fed to a melt-down unit and is melted down in the presence of slag-forming agents so that a molten slag phase and a molten metal phase are formed (step ii). The lithium (Li) contained in the molten slag phase and/or molten metal phase is then converted into a gas phase by the addition of a fluorinating agent and the carbon (C) is converted into a gas phase by the addition of an oxygen-containing gas, and said lithium and carbon are withdrawn from the process as discharge gas (step iii).

According to the method, the fraction comprising active material is reacted at high temperatures and under reducing conditions in the melt-down unit. The targeted dosing of the fluorinating agent directly fluorinates the lithium, so that it can be quantitatively withdrawn as a gas containing lithium fluoride at an early stage of the process. The recovery rate is advantageously at least 90%, more preferably at least 95%, even more preferably 99% in relation to the total amount of lithium fed into the recycling process. The lithium transferred to the gas phase in this way can subsequently be recovered directly in a subsequent condensation method. At the same time, the valuable metals, in particular cobalt and nickel, are enriched in the molten metal phase, while the less valuable metals, in particular iron and manganese, are oxidized and slagged. The process thus enables hydrometallurgical extraction of the lithium along with the valuable metals to be reduced to a minimum.

The features listed individually in the dependent formulated claims can be combined with one another in a technologically useful manner and can define further embodiments of the invention. In addition, the features indicated in the claims are further specified and explained in the description, wherein further preferred embodiments of the invention are shown.

For the purposes of the present disclosure, the term “melt-down unit” refers to a conventional bath melt-down unit or an electric arc furnace (EAF).

For the purposes of the present disclosure, the term “fraction comprising active material” is understood to mean a mixture that substantially comprises the anode and cathode material of the lithium-containing cells and/or batteries. Such fraction is extracted from the comminuted material from electrochemical energy storage devices by means of mechanical processing. The anode material typically consists of graphite, which can have incorporations of lithium ions. On the other hand, the cathode material is formed by lithium-containing transition metal oxides, so that this can have a different cell chemistry depending on the material system.

For the purposes of the present disclosure, the term “oxygen-containing gas” is understood to mean air, oxygen-enriched air or pure oxygen, which is advantageously fed to the melt-down unit via an injector.

For the purposes of the present disclosure, unless otherwise defined, the term “injector” means a lance or injection tube formed substantially of a hollow cylindrical element. In a preferred embodiment, the at least one injector can comprise a Laval nozzle via which the oxygen-containing gas is blown into the molten slag phase and/or molten metal phase. A Laval nozzle is characterized by comprising a convergent section and a divergent section, which are adjacent to each other at a nozzle throat. The radius in the narrowest cross-section, the outlet radius along with the nozzle length can be different as a function of the respective design case.

In a first embodiment, the fraction comprising active material comprises at least the elements carbon and lithium and at least one of the elements selected from the series comprising cobalt, manganese, nickel, iron and/or combinations thereof. Furthermore, at least one of the elements from the series comprising phosphorus, sulfur, vanadium, aluminum and/or copper can be present.

The method can be carried out under normal pressure or under reduced pressure. If the method is carried out at normal pressure (1 atm), the fraction comprising the active material is preferably melted down at a temperature of at least 1000° C., more preferably at a temperature of at least 1250° C., even more preferably at a temperature of at least 1450° C., and most preferably at a temperature of at least 1600° C. in the presence of the slag-forming agents. However, if the method is to be carried out at a reduced pressure, for example at a pressure of less than 1000 mbar, the fraction comprising the active material is melted down in the presence of the slag-forming agents at a temperature adapted to the respective reduced pressure.

The temperature of the gas phase and/or the discharge gas is preferably detected, continuously if necessary.

For example, FeO, CaO, SiO₂, MgO and/or Al₂O₃ can be used as slag-forming agents. If necessary, further mixed oxides such as CaSiO₃, Ca₂Si₂O₅, Mg₂SiO₄, CaAl₂O₄, etc. can be added to the process.

The molten metal phase obtained in step ii) of the method is preferably tapped off as soon as a desired concentration of the valuable metals is reached. This can then be fed to a subsequent hydrometallurgical processing step, in particular a separation and refining step. On the other hand, the molten slag phase can be granulated after it has been tapped off and used for other purposes, such as road construction.

In order to obtain a sufficiently reducing atmosphere within the melt-down unit and/or in the discharge gas, in step iii), the carbon (C) is oxidized with the oxygen-containing gas to carbon monoxide (CO). Advantageously, the proportion of carbon monoxide in the gas phase and/or in the discharge gas is detected, continuously if necessary, so that it can be regulated by correspondingly increasing or reducing the partial pressure of oxygen. The oxygen-containing gas can preferably be fed to the melt-down unit via at least one injector.

The lithium converted as a lithium fluoride containing gas is advantageously thermally reacted with carbon monoxide (CO) and oxygen in a further process stage to form lithium carbonate (Li₂CO₃). The further process stage can, for example, take the form of an afterburner chamber, in which the lithium fluoride-containing gas is converted to lithium carbonate under highly reducing conditions and at a suitable temperature.

As already explained, the targeted dosing of the fluorination agent quantitatively withdraws the lithium from the process at an early stage, while at the same time enriching the valuable metals in the molten metal phase. In order to achieve sufficient fluorination of the lithium, the content of fluorine added to the process via the fluorinating agent should be at least 0.05% by weight, preferably at least 0.5% by weight, more preferably at least 1.0% by weight, even more preferably at least 1.5% by weight and most preferably at least 2.0% by weight in relation to the amount of active material fed to the process in accordance with step ii).

Since some of the valuable transition metals, in particular cobalt and/or the nickel, can likewise react with the fluorinating agent in a competitive reaction and thus the desired separation between the lithium and the valuable transition metals can be impaired, the content of fluorine added to the process via the fluorinating agent should not exceed 15.0% by weight, preferably a maximum of 12.5% by weight, more preferably a maximum of 10.0% by weight, even more preferably a maximum of 8.5% by weight and most preferably a maximum of 7.5% by weight, in relation to the amount of active material fed to the process in accordance with step ii).

Therefore, advantageously, a fluorine content of 0.05 to 15.0% by weight, more preferably a fluorine content of 0.5 to 12.5% by weight, even more preferably a fluorine content of 1.0 to 10.0% by weight, further preferably a fluorine content of 1.5 to 8.5% by weight, and most preferably a fluorine content of 2.0 to 7.5% by weight in relation to the amount of active material fed to the process in accordance with step ii) is added to the process via the fluorinating agent. In this connection, it is particularly preferred that the proportion of lithium fluoride-containing gas in the gas phase and/or in the discharge gas is detected, continuously if necessary, so that the amount of fluorinating agent can be regulated accordingly.

In a particularly preferred embodiment of the method, an electrolyte of the lithium-containing energy storage devices that preferably comprises lithium hexafluorophosphate (LiPF₆) is used as the fluorinating agent. For this purpose, it is advantageously provided that a fraction comprising the electrolyte is separated from the electrochemical energy storage devices and/or from the comminuted material, which is then used as the fluorinating agent in accordance with step iii). On the one hand, this can further increase the recovery rate of lithium. On the other hand, the recycling process is largely carried out based on the components of the lithium-containing energy storage devices.

If the fraction comprising active material comprises aluminum, the aluminum content can have a significant thermodynamic influence on the recovery rate of lithium. In order to guarantee an efficient process, the fraction comprising active material should therefore comprise a maximum proportion of aluminum of 10.0% by weight, preferably a maximum proportion of aluminum of 7.0% by weight, more preferably a maximum proportion of aluminum of 6.0% by weight, even more preferably a maximum proportion of aluminum of 5.0% by weight, and most preferably a maximum proportion of aluminum of 4.5% by weight, in relation to the amount of active material fed to the process in accordance with step ii).

The partial pressure of oxygen can also have a significant thermodynamic influence on the recovery rate of lithium. To achieve the reducing conditions, a specific content of oxygen is required, which is oxidized to carbon monoxide with the carbon contained in the process. However, an excessively high partial pressure of oxygen in turn promotes the formation of metal oxides, which is undesirable. Due to the respective process-specific parameters, it must therefore always be adapted to the respective process conditions.

In a particularly advantageous embodiment, the process is carried out in the presence of a carrier gas, which may be inert, in particular in the presence of nitrogen, which is used as the carrier gas. In an alternative embodiment, air or oxygen-enriched air can also be used as the carrier gas. Thereby, it has been shown that a continuous flow rate of at least 300 Nm³/h, preferably a continuous flow rate of at least 500 Nm³/h, more preferably a continuous flow rate of at least 750 Nm³/h, even more preferably a continuous flow rate of at least 900 Nm³/h, and most preferably a continuous flow rate of at least 1000 Nm³/h, in relation to an amount of 1000 kg of active material fed to the process in accordance with step ii), has a particularly advantageous effect on the recovery rate. In order to regulate the flow rate of the carrier gas accordingly, it is detected, continuously if necessary.

### BRIEF DESCRIPTION OF THE DRAWINGS

FIGS. 1 to 9 show graphs illustrating the relationship of Li recovery rate, Al proportion and temperature in simulation results.

### DETAILED DESCRIPTION

The invention and the technical environment are explained in more detail below with reference to the exemplary embodiments. It should be noted that the invention is not intended to be limited by the exemplary embodiments shown. In particular, unless explicitly shown otherwise, it is also possible to extract partial aspects of the facts explained in the illustrated exemplary embodiments and/or figures and to combine them with other components and findings from the present description.

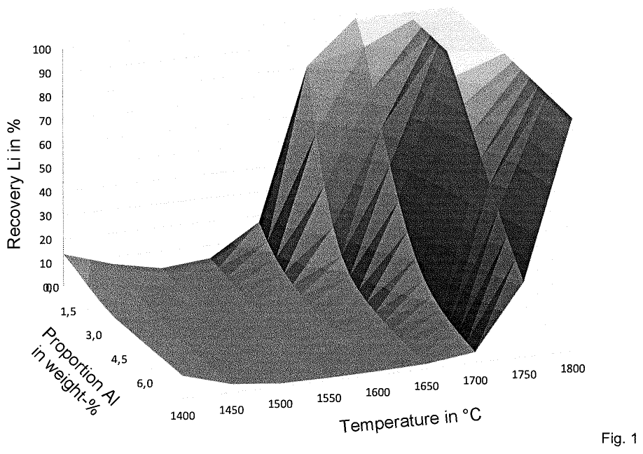

FIGS. 1 to 9 show the results of various examples that were carried out using a simulation tool from Factsage™. The FactPS, FToxid, FTmisc and FScopp databases were used for the calculations.

A fraction comprising active material with a composition in accordance with Table 1 below, which was analytically determined from crushed lithium-containing batteries, was used as input variables.

TABLE 1

| | C | Co | Cu | Mn | Ni | O | P | Si |
|---|---|---|---|---|---|---|---|---|
| Units of mass | 30 | 6 | 2.6 | 9 | 11 | 17 | 0.6 | 0.5 |

In the thermodynamic calculations carried out, the following aspects of mass and energy transfer, temperature, partial pressure of oxygen of the carrier gas flow and chemistry were considered in order to investigate the distribution of the respective elements in the molten slag phase, in the molten metal phase and in the gas phase.

The following elements and compounds were identified as typical species in the gas phase: LiF; Li; (LiF)₂; (LiF)₃; Li₂O; LiN; LiAlF₄; Li₂AlF₅; LiO; AlF₃;

The following elements and compounds can be identified as typical species in the molten slag phase: Al₂O₃; SiO₂; CoO; NiO; MnO; Cu₂O; Mn₂O₃; Li₂O; LiAlO₂; P₂O₅; LiF; LiAlF₄; and small proportions of metal halides of Co; Cu; and Ni;

The molten metal phase contained the following elements: Co; Cu; Ni; Mn; C; P; Si; Li; Al; Fe;

There was also an excess of graphite.

For the results shown in FIGS. 1 to 3, thermodynamic equilibrium calculations were carried out with the parameters shown in Table 2:

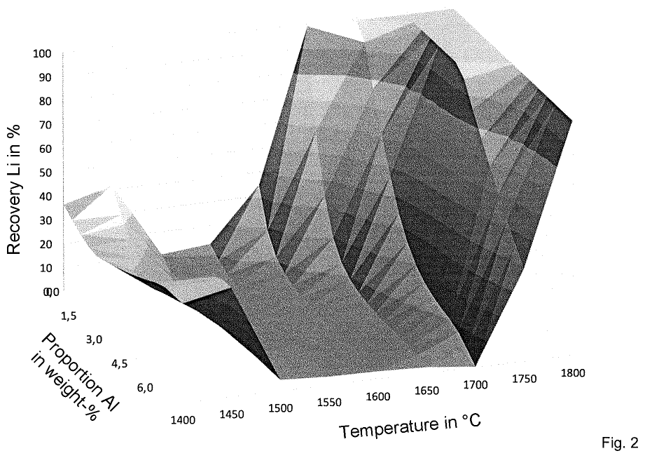

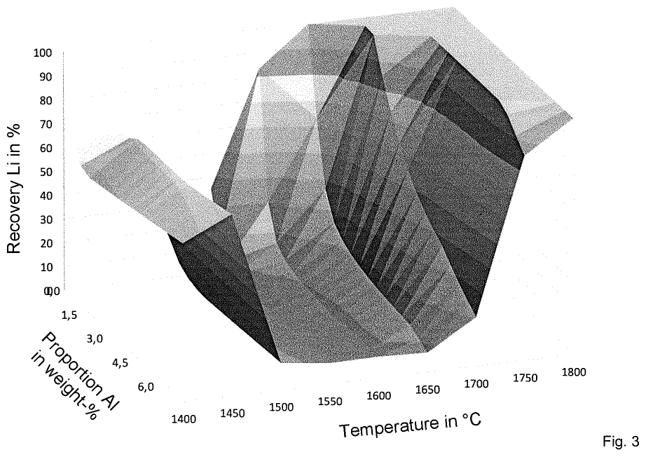

TABLE 2

| | | | Nitrogen as the | | |
|---|---|---|---|---|---|
| | | | carrier gas | | |
| F | Al | | [Nm³/h related | | |
| [Units | [Units | Temperature | to 1000 kg active | pO₂ | |
| of mass] | of mass] | [° C.] | material] | [atm] | FIG. |
| 1 | 0 to 7 | 1400-1800 | 10 | 10⁻¹⁶ | FIG. 1 |
| 4 | | | | | FIG. 2 |
| 7 | | | | | FIG. 3 |

The results illustrated in FIGS. 1 to 3 show, on the one hand, that the conversion of lithium in the gas phase increases with increasing temperature and, on the other hand, that an increasing fluorine content promotes the thermodynamic processes, whereas an increasing Al content in the active material impairs them.

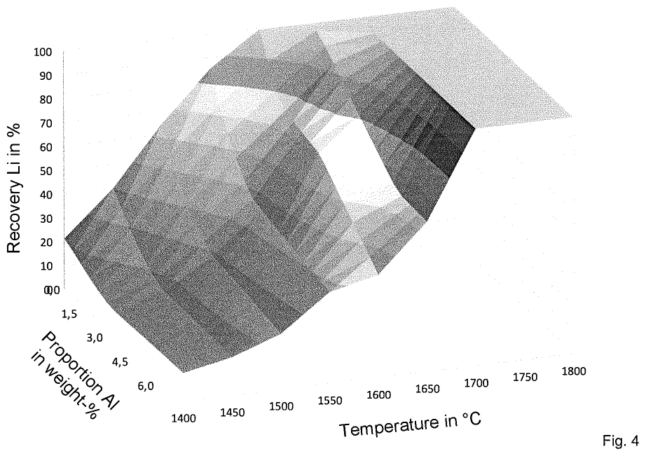

For the results shown in FIGS. 4 to 6, thermodynamic equilibrium calculations were carried out with the parameters shown in Table 3:

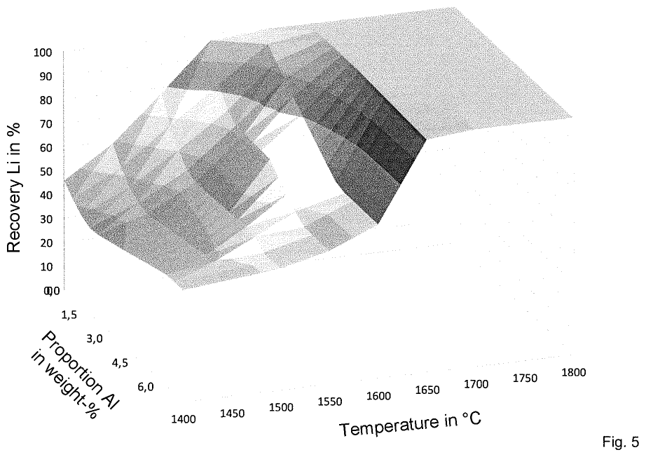

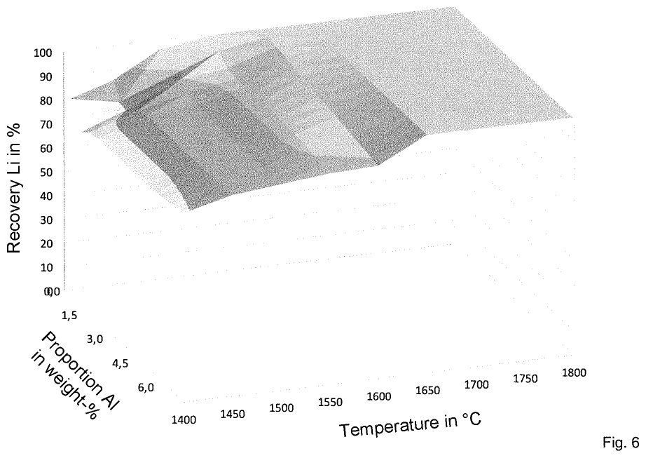

TABLE 3

| | | | Nitrogen as the | | |
|---|---|---|---|---|---|
| | | | carrier gas | | |
| F | Al | | [Nm³/h related | | |
| [Units | [Units | Temperature | to 1000 kg active | pO₂ | |
| of mass] | of mass] | [° C.] | material] | [atm] | FIG. |
| 1 | 0 to 7 | 1400-1800 | 500 | 10⁻¹⁶ | FIG. 4 |
| 4 | | | | | FIG. 5 |
| 7 | | | | | FIG. 6 |

In comparison to the results shown in FIGS. 1 to 3, it can be seen here that a high continuous flow of carrier gas favors the thermodynamic reaction.

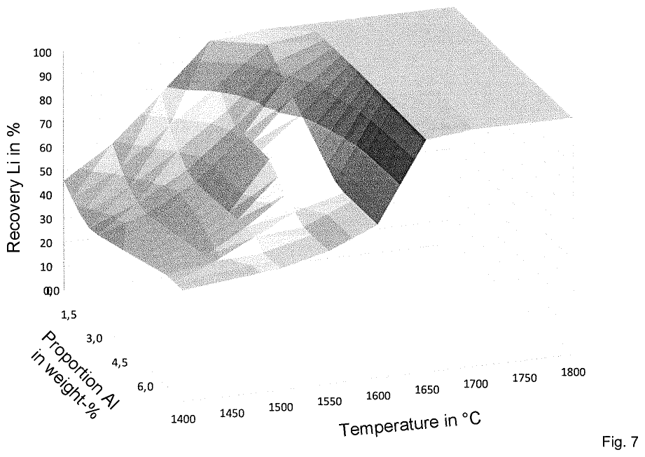

For the results shown in FIGS. 7 to 9, thermodynamic equilibrium calculations were carried out with the parameters shown in Table 4:

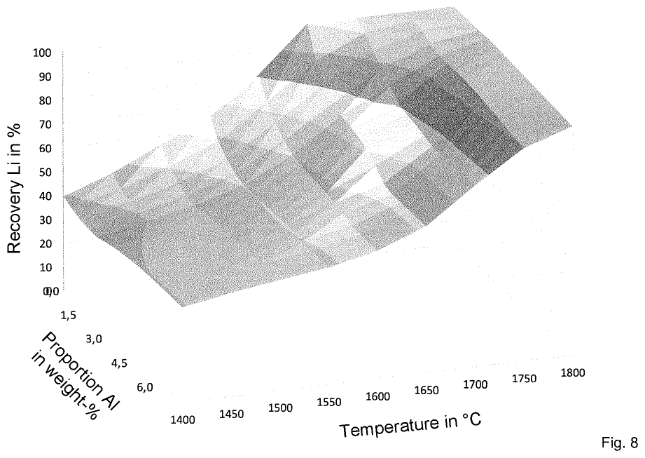

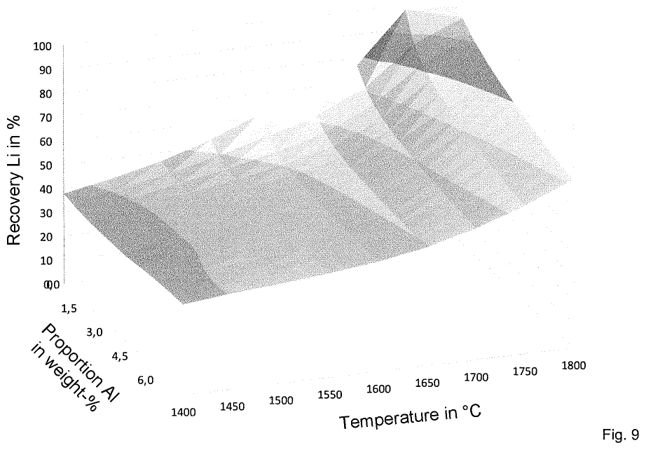

TABLE 4

| | | | Nitrogen as the | | |
|---|---|---|---|---|---|
| | | | carrier gas | | |
| F | Al | | [Nm³/h related | | |
| [Units | [Units | Temperature | to 1000 kg active | pO₂ | |
| of mass] | of mass] | [° C.] | material] | [atm] | FIG. |
| 4 | 0 to 7 | 1400-1800 | 500 | 10⁻¹⁶ | FIG. 7 |
| 4 | | | | 10⁻¹⁴ | FIG. 8 |
| 4 | | | | 10⁻¹² | FIG. 9 |

To further investigate the influence of the partial pressure of oxygen, only the value of the partial pressure of oxygen was varied in examples 7 to 9, leaving the other parameters unchanged. In comparison to the previous examples, it can be seen here that a low partial pressure of oxygen favors the thermodynamic reaction due to the better reducing conditions.

1.-12. (canceled)

13. A method for recycling lithium-containing electrochemical energy storage devices, comprising:
comminuting the lithium-containing electrochemical energy storage devices to form a comminuted material and separating an active material fraction from the comminuted material, wherein the active material fraction comprises
carbon (C),
lithium (Li), and
at least one of the elements selected from the group consisting of cobalt (Co), manganese (Mn), nickel (Ni), and iron (Fe);
subsequently feeding the active material fraction to a melt-down unit and melting down the active material fraction in presence of slag-forming agents, thereby forming a molten slag phase and a molten metal phase;
converting the lithium (Li) contained in the molten slag phase and/or in the molten metal phase into a gas phase by adding a fluorinating agent;
converting the carbon (C) into a gas phase by adding an oxygen-containing gas; and
withdrawing the lithium and the carbon as discharge gas.

14. The method according to claim 13,
wherein converting the lithium (Li) contained in the molten slag phase and/or in the molten metal phase into the gas phase produces a lithium fluoride-containing gas, and
wherein converting the carbon (C) into the gas phase includes oxidizing the carbon (C) with the oxygen-containing gas to carbon monoxide (CO).

15. The method according to claim 14, further comprising
thermally reacting the lithium fluoride-containing gas with the carbon monoxide (CO) and oxygen to form lithium carbonate (Li₂CO₃).

16. The method according to claim 13,
wherein a fluorine content of 0.05 to 15.0% by weight is added via the fluorinating agent in relation to the active material fraction.

17. The method according to claim 14, further comprising
continuously detecting a proportion of the lithium fluoride-containing gas and/or a proportion of the carbon monoxide (CO) in the gas phase and/or in the discharge gas.

18. The method according to claim 13, wherein the method is carried out in the presence of a carrier gas.

19. The method according to claim 18, wherein the carrier gas is nitrogen.

20. The method according to claim 18, wherein the carrier gas is blown into the melt-down unit at a flow rate of at least 300 Nm³/h in relation to an amount of 1000 kg of active material.

21. The method according to claim 20, wherein the carrier gas is blown into the melt-down unit at a flow rate of at least 1000 Nm³/h in relation to an amount of 1000 kg of active material.

22. The method according to claim 20, further comprising
continuously detecting the flow rate of the carrier gas.

23. The method according to claim 13, further comprising
continuously detecting a temperature of the gas phase and/or of the discharge gas.

24. The method according to claim 13, further comprising
separating an electrolyte-comprising fraction from the lithium-containing electrochemical energy storage devices and/or from the comminuted material, and
using the electrolyte-comprising fraction as the fluorinating agent.

25. The method according to claim 24, wherein the electrolyte-comprising fraction comprises lithium hexafluorophosphate (LiPF₆).

26. The method according to claim 13,
wherein the active material fraction comprises aluminum (Al) in a proportion of at most 10.0% by weight.
